(19) United States
(12) Patent Application Publication
(10) Pub. No.: US 2021/0356043 A1
(43) Pub. Date: Nov. 18, 2021

(54) SEALING RING AND SEAL ASSEMBLY COMPRISING THE SEALING RING

(71) Applicant: Carl Freudenberg KG, Weinheim (DE)

(72) Inventor: Marc-Christian Voehringer, Albbruck (DE)

(21) Appl. No.: 17/317,915

(22) Filed: May 12, 2021

(30) Foreign Application Priority Data
May 14, 2020 (DE) 10 2020 113 090.2

(51) Int. Cl. F16J 15/3204; F16J 15/3284

(52) U.S. Cl. CPC F16J 15/3204; F16J 15/3284

(57) ABSTRACT

A sealing ring includes: an elastomeric sealing material which, when viewed in cross section, is substantially T-shaped; a support element extending in an axial direction; and a sealing lip extending in a radial direction. The sealing lip is elastically yielding and has a base which is formed as transitioning into the support element.

### CROSS-REFERENCE TO PRIOR APPLICATION

Priority is claimed to German Patent Application No. DE 10 2020 113 090.2, filed on May 14, 2020, the entire disclosure of which is hereby incorporated by reference herein.

### FIELD

The invention relates to a sealing ring made of an elastomeric sealing material.

### BACKGROUND

Such a sealing ring is generally known and is designed, for example, as an O-ring. An O-ring has a circular cross section and is rotationally symmetrical about its axial central axis. O-rings are normally used for the mutual static sealing of two machine elements and substantially seal off in the radial direction. A first machine element to be sealed has an installation space for the O-ring, wherein the O-ring projects radially beyond the installation space in the direction of a second machine element to be sealed and fits sealingly against the latter under radial elastic pretensioning.

One of the machine elements to be sealed against one another can be designed as a rod, the other machine element to be sealed as a housing surrounding the rod.

During its intended use, an O-ring is compressed on average by approximately 20% in its installation space in order to ensure reliable static sealing. The pressing of the O-ring usually takes place via insertion bevels on the machine elements when mounting the sealing arrangement. The insertion bevels prevent damage to the O-ring during assembly of the sealing arrangement. Nevertheless, pressing the O-ring requires a relatively high mounting force due to the almost approximate internal compressibility and the poor frictional properties of the elastomer, even if the frictional properties of the O-ring are improved, for example, by coating its surface or a mounting tray.

At the same time, insertion bevels have manufacturing and economic disadvantages because they have to be produced with extra effort. Furthermore, it is disadvantageous that insertion bevels require additional axial installation space, which is often not present in applications that are compact in the axial direction. For such applications, the insertion bevels would have to be reduced or omitted, which makes process-safe mounting of the sealing ring difficult without damage.

A further disadvantage of O-rings is that only comparatively small eccentricities of the machine elements to be sealed against one another can be compensated for. The production process of machine elements to be sealed against one another with only small manufacturing tolerances is complicated and expensive in terms of design when O-rings are to be used for the static sealing of the machine elements.

However, permissible eccentricities of the machine elements relative to one another, which would lead to a reduction in the production costs of the sealing arrangement, cannot be reliably sealed by O-rings.

### SUMMARY

In an embodiment, the present invention provides a sealing ring, comprising: an elastomeric sealing material which, when viewed in cross section, is substantially T-shaped; a support element extending in an axial direction; and a sealing lip extending in a radial direction, wherein the sealing lip is elastically yielding and has a base which is formed as transitioning into the support element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIGS. 1 and 2 each show one sealing arrangement.

In FIGS. 3a to 3d, the mounting of the sealing ring of the sealing arrangement is depicted schematically, by way of example with reference to a piston seal.

### DETAILED DESCRIPTION

In an embodiment, the present invention provides a further development of a sealing ring of the type mentioned at the beginning in such a way that it can be mounted with a low assembly force in a process-safe manner and without damage to a sealing arrangement in which the machine elements to be sealed against one another have no insertion bevels and/or eccentricities relative to one another.

In an embodiment, the present invention provides a sealing ring made of an elastomeric sealing material is provided which, when viewed in cross section, is substantially T-shaped and comprises a support element extending in the axial direction and a sealing lip extending in the radial direction and being elastically yielding, wherein the sealing lip has a basis which is formed as transitioning into the support element.

The sealing lip, which extends in the radial direction and is integrally formed with its base transitioning into the support element, is essential to the invention. In contrast to the O-rings mentioned at the beginning, which are pressed between the machine elements to be sealed against one another, the sealing lip flexibly hinged to the support element nestles resiliently against the surface to be sealed of the machine element facing the sealing lip. Due to the flexibility of the sealing lip and because it follows the form of the surface to be sealed, eccentricities of the machine elements to be sealed against one another, based on O-rings, can also be compensated for. The mounting force of the sealing ring of the invention does not increase as high as in the case of O-rings when the sealing ring is mounted with greater eccentricities. The manufacturing tolerances of the machine elements may be greater, and production may therefore be more cost-effective. The position of the sealing lip is stabilized by the support element. Any tilting of the sealing ring in its installation space is prevented by the support element.

The sealing ring is preferably rotationally symmetrical.

According to an advantageous embodiment, the support element and the sealing lip can be formed integrally transitioning into one another with uniform material. By means of such an embodiment, the sealing ring can be produced simply and cost-effectively and—after its use—can be simply recycled because it is unmixed material.

The support element can have an end face in the axial direction on both sides and be curved from one end face to the other and be curved radially in the direction of the sealing lip. Due to the arched configuration of the support element, it has spring properties similar to the spring properties of a disk spring. The spring force and thereby the radial pressure of the sealing lip on the surface of the machine element facing the sealing lip depends on the eccentricities of the machine elements to be sealed against one another via the spring travel of the support element in the radial direction, but nevertheless largely constant. Even when sealing differently great pressures and joint-like movements of the sealing lip about its base on the support element, the sealing lip rests against the surface of the corresponding machine element to be sealed with sufficient prestress. The arched protrusion of the support element is usually maintained during the intended use of the sealing ring to compensate for conventional eccentricities of the machine elements to be sealed against one another. Only to compensate for unusually high eccentricity is the support part pressed flat against the groove base of the installation groove of the sealing ring. Eccentricities of the machine elements to be sealed against one another can be well compensated with little expenditure of force.

There is a possibility of influencing the radial height of the sealing lip by the dimension of the radial protrusion. The shorter the sealing lip in the radial direction, the higher the pressure of the medium to be sealed.

The arched support element has a first radius of curvature on the side facing away radially from the sealing lip and a second and third radius of curvature on the side facing radially toward the sealing lip, axially on both sides of the sealing lip. For a uniformly flexible deformation of the support element axially on both sides of the sealing lip, it is advantageous if these regions are embodied substantially identically. A tilting of the sealing ring in the installation space is thereby effectively reduced in conjunction with the arched protrusion of the support element.

The stronger the sealing ring is pressed in the radial direction and thus the arched contour of the support element is progressively removed, the more the axial support surface becomes larger, and the sealing ring thus automatically becomes more tilt-stable at a higher radial pressure.

In an advantageous embodiment, it can be provided that all radii of curvature in the production-related state of the sealing ring have an identical center point and/or are substantially the same. Through the same radii of curvature, the thickness of the support element is substantially constant along its axial extent. Production is thereby possible with particularly high process reliability. Undesired accumulations of material in the support element, which could lead to defects in the support element with disadvantageous use properties, are thereby prevented.

Depending on the respective conditions of the application case, the radii of curvature may differ from one another and/or they need not have the same center point. This makes it possible, for example, for the first radius of curvature to be smaller, for the second and the third radius of curvature to be the same and to be greater relative to the first radius of curvature. As a result, the sealing ring has a comparatively large spring travel in the radial direction, relative to compact dimensions in the axial direction.

The second and third radius of curvature may together form a uniformly transitioning exterior radius of curvature.

The first radius of curvature can be formed on both end sides in the axial direction, in each case in an axially extending and planar support surface. The tilting tendency of the sealing ring in its installation space during assembly and during the intended use of the sealing ring is further reduced by the planar support surface extending in the axial direction.

The support surfaces can be formed as rounded, transitioning into the corresponding end faces. Such an embodiment can be produced in a simple manner, and the end faces, if required, follow in a planar manner the delimiting walls of an installation groove adjoining in the axial direction respectively.

The sealing lip can have a substantially semicircular boundary on the side facing away radially from the support element. The semicircular delimitation has the advantage that it always rests, largely independently of a possible tilting of the sealing ring/deformation of the sealing lip, with a similarly large contact surface on the sealing surface of the machine element to be sealed that adjoins in the radial direction. It is furthermore advantageous that, due to the semicircular delimitation, joining force fluctuations in the case of eccentricities of various dimensions of the machine elements to be sealed against one another are avoided.

The base can be formed axially on both sides with a fourth and a fifth radius of curvature transitioning into the second and third radius of curvature. With regard to the second and third radius of curvature, the fourth and fifth radius of curvature are substantially smaller. The fourth and fifth radius of curvature are preferably the same in the production-related state of the sealing ring. Due to the comparatively small fourth and fifth radius of curvature, the sealing lip can be moved in the region of its base with only little force. As a result, during its intended use, the sealing ring can also easily be adapted to specific embodiments of sealing arrangements, in particular to different eccentricities of the machine elements to be sealed against one another.

An imaginary radial plane can be arranged centrally in the axial direction of the sealing ring, wherein the sealing ring is preferably configured symmetrically to the radial plane. Such a sealing ring is simple to produce and during its assembly, the direction in which it is installed does not matter due to the symmetry; the risk of assembly errors is thus reduced to a minimum.

Viewed in the radial plane, the thickness of the support element in the radial direction can substantially correspond to the height of the sealing lip in the radial direction.

Generally, the shorter the flexible sealing lip in the radial direction, the higher the pressure of the medium to be sealed. In particular in the sealing of comparatively small differential pressures at the sealing lip in the region of approximately 1 bar, the embodiment described above has proven to be advantageous because such an embodiment ensures a good compromise between satisfactory flexibility of the sealing lip and sufficiently strong contact pressure at the sealing surface of the corresponding machine element.

According to a first embodiment, the support element can be arranged radially inside the sealing ring, the sealing lip on the exterior of the sealing ring in the radial direction, wherein the sealing ring then is designed as a piston sealing ring. According to a second embodiment, there is the possibility that the sealing ring is designed as a rod sealing ring. The support element is then arranged in the radial direction on the exterior of the sealing ring, and the sealing lip is arranged in the radial direction inside the sealing ring.

In both cases, as a piston sealing ring or as a rod sealing ring, the sealing ring of the invention works well.

The sealing ring may have an axial cord thickness and a radial cord thickness, wherein the ratio of axial to radial cord thickness is >1. Further preferably, the ratio is 1.1 to 1.3. The cord thicknesses relate to the production-related state of the sealing ring. Such a ratio ensures that the sealing ring always has a given extent in the axial direction than in the radial direction. The risk of tilting of the sealing ring during assembly and under pressurization during its intended use is thereby greatly reduced.

The sealing lip extends from its base to the semicircular boundary with boundary surfaces that extend substantially in the radial direction.

The extent of the sealing lip in the axial direction is smaller than in the radial direction. As a result, the sealing lip has a high degree of flexibility and thus a good adaptation to various installation situations, in particular installation situations with eccentricities deviating from one another.

In such an embodiment, it is advantageous that the sealing ring has only a slight tilting tendency due to the comparatively great flexibility of the sealing lip that is thinner relatively to the support element during assembly or during the intended use. The less the sealing ring tilts in the sealing arrangement, the better the sealing function.

The invention furthermore relates to a sealing arrangement, comprising a sealing ring, in which the sealing ring is arranged in the radial direction inside the sealing ring, the sealing lip is arranged in the radial direction of the sealing ring, wherein the sealing ring is formed as a piston sealing ring, with a production-related interior diameter di and two machine elements to be sealed against one another, the first machine element being formed as a rod to be sealed, the second as a housing encompassing the rod, wherein the first machine element has an installation groove for the sealing ring that is open radially in the direction of the second machine element, with a groove base having a diameter dN and wherein the ratio of di to dN is 0.85 to 0.95. The inner diameter of the sealing ring is thus approximately 10% smaller than the groove base of the installation groove when rated. The sealing ring therefore has an expansion in the radial direction after its mounting in the installation groove. The expansion reduces the tilting tendency of the sealing ring during its intended use.

Another sealing arrangement comprises a sealing ring, in which the support element is arranged in the radial direction on the exterior the sealing ring, the sealing lip is arranged in the radial direction on the inside of the sealing ring, wherein the sealing ring is formed as a rod sealing ring, with a production-related exterior diameter da and two machine elements to be sealed against one another, the first machine element being formed as a housing, the second as a substantially concentrically arranged rod in the housing, wherein the first machine element has an installation groove for the sealing ring that is open radially in the direction of the second machine element, with a groove base having a diameter dN and wherein the ratio of da to dN is 1.01 to 1.05. When rated, the sealing ring is thereby slightly compressed in order to achieve a similar effect as described above for the piston sealing ring. The tilting tendency of the sealing ring is also reduced by the compression. However, the compression of the rod sealing ring is less than the expansion of the piston sealing ring because the elastomeric materials the sealing ring consists of are approximately incompressible.

The installation grooves of the previously described sealing arrangements are preferably of substantially rectangular design, viewed in section. As a result, they can be produced easily and cost-effectively.

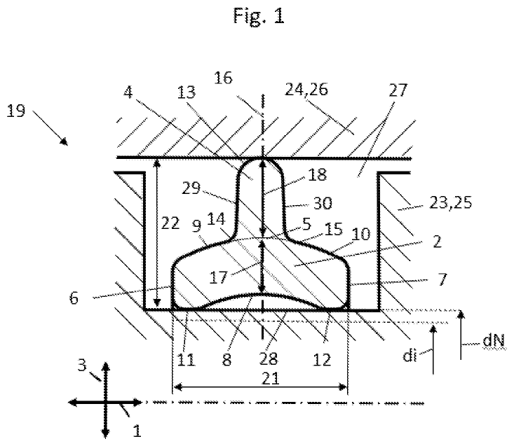

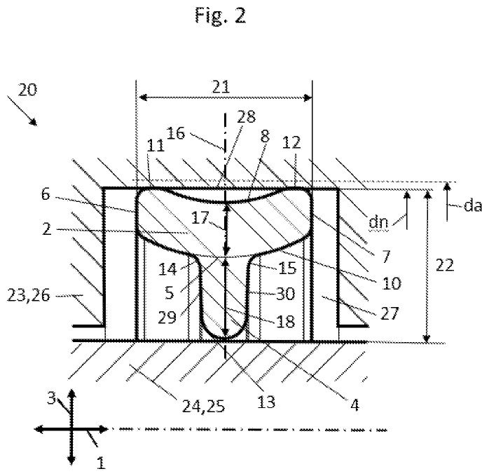

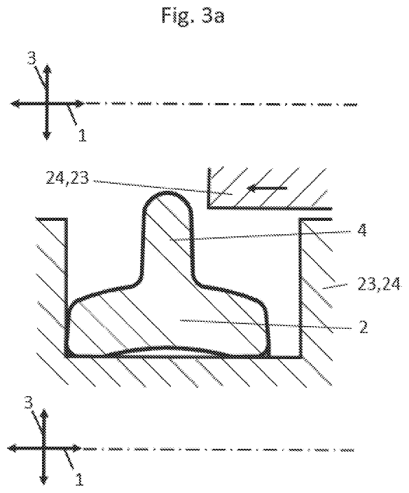

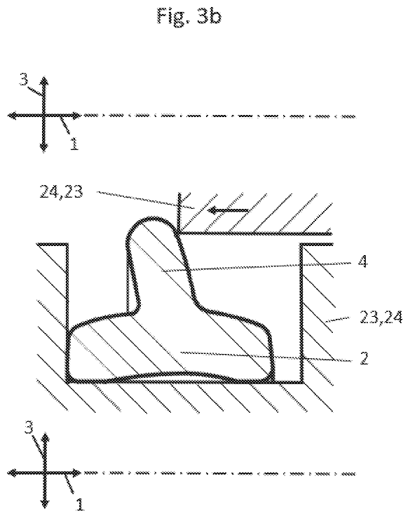

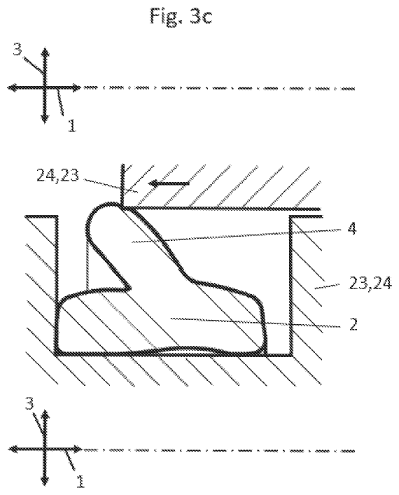

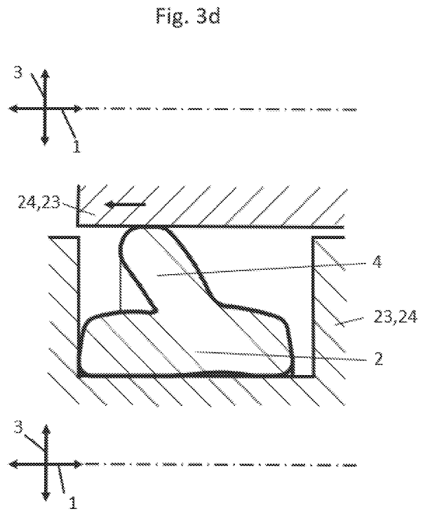

Two exemplary embodiments of a sealing arrangement of the invention with a sealing ring of the invention are explained in more detail below with reference to the FIGS. 1 and 2 shown schematically, wherein the sealing ring is configured as a piston sealing ring in the sealing arrangement of FIG. 1, and the sealing ring in the sealing arrangement in accordance with FIG. 2 is configured as a rod sealing ring.

In the schematically illustrated FIGS. 3a to 3d, the mounting of a sealing arrangement is exemplarily shown, wherein the sealing ring can be designed as a piston sealing ring or as a rod sealing ring.

In FIG. 1, the sealing ring is designed as a piston sealing ring 19, in FIG. 2 as a rod sealing ring 20.

In both cases, the sealing ring consists of an elastomeric sealing material and, viewed in the cross section shown here, is of substantially T-shaped design. The sealing ring comprises the support element 2 which extends in the axial direction 1 and the sealing lip 4 which extends in the radial direction 3, wherein the support element 2 and the sealing lip 4 are formed as one part transitioning into one another and are of uniform material. The base 5 of the sealing lip 4 merges into the support element 2.

The support element 2 extends as an arch from one end face 6 to the other 7 and is curved outwards radially in the direction of the sealing lip 4.

In the sealing arrangements shown here, no differential pressure acts on the sealing lips 4.

The support element 2 has a several radii of curvature 8, 9, 10, wherein the support element 2 has the first radius of curvature 8 on the side facing radially away from the sealing lip 4 and the second 9 and third radius of curvature 10 on the side facing radially toward the sealing lip 4, axially on both sides of the base 5 of the sealing lip 4.

The axial cord thickness 21 of the sealing rings is somewhat greater than the radial cord thickness 22, wherein the ratio of the axial 21 to the radial cord thickness 22 in the exemplary embodiments shown here is about 1.2. The cord thicknesses 21, 22 each relate to the production-related state of the sealing rings.

In order to minimize the tilting tendency of the sealing ring during the assembly of the sealing arrangement and during its intended use in the sealing arrangement, the support surfaces 11, 12 extending in the axial direction 1 are provided with which the sealing ring is supported stably on the groove base 28 of the installation groove 27.

Furthermore, the tilting tendency of the sealing ring is reduced even further by the end faces 6, 7 since the sealing ring with its end faces 6, 7 is displaced during its mounting at sufficient frictional ratios to the corresponding end faces of the installation groove. The facing end faces of the support element and the installation groove are thus positioned on top of each other.

The sealing lip 4 is delimited on its side facing radially away from the support element 2 by a semicircular boundary 13, wherein the delimiting walls 29, 30 of the sealing lip 4 are arranged in the axial direction extending substantially in the radial direction 3. Depending on the respective conditions of the application and the desired use properties of the sealing ring, the delimiting walls 29, 30 can have a small angle with one another; in particular, the sealing lip 4 can slightly taper radially in the direction of its boundary 13. The degree of elastic compliance of the sealing lip along its radial extent can thereby be influenced in a targeted manner. The transition from the boundary walls 29, 30 into the radii of curvature 9, 10 takes place through the fourth radius of curvature 14 and the fifth radius of curvature 15 which, relative to the radii of curvature 9, 10 are substantially smaller, so that the sealing lip 4 has good flexibility.

In both exemplary embodiments, the sealing ring is arranged symmetrically to the imaginary radial plane 16. In the radial plane 16, the thickness 17 of the support element 2 in the radial direction 3 is similar to the height 18 of the sealing lip 4 in the same direction 3.

In FIG. 1, the sealing ring, as described above, is designed as a piston sealing ring 19. It has a production-related inner diameter di and is arranged between the two machine elements 23, 24 to be sealed against one another. The first machine element 23 is designed as a rod 25 and the second machine element 24 as a housing 26 which circumferentially surrounds the rod 25 at a radial distance, wherein the sealing ring is arranged in the gap formed by the spacing. The first machine element 23 has the installation groove 27 for the sealing ring which is open radially in the direction of the second machine element 24. The installation groove 27 is rectangular in the section shown and has a groove base 28 with a diameter dN. The ratio of the inner diameter di of the sealing ring 4 to the diameter of the groove base dN is approximately 0.9 in the exemplary embodiment shown here. As a result, the sealing ring is expanded in the radial direction 3 and the tilting tendency of the sealing ring in the installation groove 27 is reduced.

In contrast to this, the sealing ring in FIG. 2 is formed as a rod sealing ring 20. The support element 2 is here arranged in the radial direction 3 on the exterior of the sealing ring, the sealing lip 4 is arranged in the radial direction inside the sealing ring. In its production-related state, the sealing ring has an exterior diameter da which is greater than the diameter dN of the groove base 28 of the installation groove 27. In the exemplary embodiment shown here, the first machine element 23 is a housing 26 and the second machine element 24 is a rod 25 arranged concentrically in the housing 26 and surrounded circumferentially at a radial distance by the housing 26. The first machine element 23 has an installation groove 27 for the sealing ring which is open radially in the direction of the second machine element 24 and is rectangular in shape. In the exemplary embodiment shown, the sealing ring is compressed by approximately 3% in order to effect a tilting-stable positioning of the sealing ring in the installation groove 27.

Even if the two machine elements 23, 24 to be sealed against one another are arranged offset relative to one another with greater eccentricities and/or have no insertion bevels in order to facilitate the mounting of the sealing ring, the sealing result is excellent and the sealing arrangement can be mounted with a comparatively small joining force without damaging the sealing ring during assembly. This is due to the good flexibility of the sealing lip 4 compared to an O-ring and the good elastic compliance of the arch-shaped support element 2 in the radial direction 3. The support element 2 can absorb part of the radial pressing and thus reduces the tilting tendency of the flexible sealing lip 4.

In FIGS. 3a to 3d, the mounting of the sealing ring of the sealing arrangement is depicted schematically, by way of example with reference to a piston seal. The sealing ring is arranged in an installation groove 27 of one of the machine elements 23, 24, wherein the sealing lip 4 projects radially in the direction of the respective other machine element 24, 23. In the exemplary embodiment shown, this machine element 24, 23 is designed without insertion bevels, so that it can be produced simply and cost-effectively.

When the machine element 24, 23 is mounted in the axial direction 1 above the machine element 23, 24 and thus above the sealing ring arranged in the installation groove 27, the sealing lip 4 increasingly folds over in the mounting direction of the machine element 24, 23 in the axial direction 1 as shown in FIGS. 3a to 3d.

Due to the good flexibility of the sealing lip 4 in the region of the base 5 and due to the semicircular boundary 13 in conjunction with the arch-shaped support element 2, the two machine elements 23, 24 are reliably sealed against one another by the sealing ring.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A sealing ring, comprising:
an elastomeric sealing material which, when viewed in cross section, is substantially T-shaped;
a support element extending in an axial direction; and
a sealing lip extending in a radial direction,
wherein the sealing lip is elastically yielding and has a base which is formed as transitioning into the support element.

2. The sealing ring of claim 1, wherein the support element and the sealing lip are formed as transitioning into one another and comprise a same material.

3. The sealing ring of claim 1, wherein the support element has one end face on both sides in the axial direction, and
wherein the support element is curved from one end face to an other end face and is curved radially in a direction of the sealing lip.

4. The sealing ring of claim 1, wherein the support element has a first radius of curvature on a side facing radially away from the sealing lip and a second and third radius of curvature on a side facing radially toward the sealing lip, axially on both sides of the sealing lip.

5. The sealing ring of claim 4, wherein all radii of curvature in a production-related state of the sealing ring have a same center point and/or are substantially the same.

6. The sealing ring of claim 4, wherein the first radius of curvature in the axial direction is formed at a front side on both sides, transitioning into a planar support surface extending in the axial direction respectively.

7. The sealing ring of claim 6, wherein the support surfaces are rounded into corresponding end faces.

8. The sealing ring of claim 1, wherein the sealing lip has a substantially semicircular boundary on a side facing away radially from the support element.

9. The sealing ring of claim 4, wherein the base is formed axially on both sides with a fourth and a fifth radius of curvature transitioning into the second and third radius of curvature.

10. The sealing ring of claim 1, wherein an imaginary radial plane is arranged centrally with respect to the sealing ring in the axial direction, and
wherein the sealing ring is configured symmetrically with respect to a radial plane.

11. The sealing ring of claim 10, wherein, when viewed on the radial plane, a thickness of the support element in the radial direction substantially corresponds to a height of the sealing lip in the radial direction.

12. The sealing ring of claim 1, wherein the support element is arranged in the radial direction inside the sealing ring and the sealing lip is arranged in the radial direction on an exterior of the sealing ring, and
wherein the sealing ring comprises a piston sealing ring.

13. The sealing ring of claim 1, wherein the support element is arranged in the radial direction on an exterior of the sealing ring and the sealing lip is arranged in the radial direction inside the sealing ring, and
wherein the sealing ring comprises a rod sealing ring.

14. The sealing ring of claim 1, wherein the sealing ring has an axial cord thickness and a radial cord thickness, and
wherein a ratio of axial cord thickness to radial cord thickness is >1.

15. The sealing ring of claim 14, wherein the ratio is 1.1 to 1.3.

16. A sealing arrangement, comprising:
the sealing ring of claim 12, the sealing ring having a production-related inner diameter di; and
two machine elements to be sealed against one another, the first machine element comprising a rod to be sealed, the second machine element comprising a housing encompassing the rod,
wherein the first machine element has an installation groove for the sealing ring that is open radially in a direction of the second machine element, with a groove base which has a diameter dN, and
wherein a ratio of di to dN is 0.85 to 0.95.

17. A sealing arrangement, comprising:
the sealing ring of claim 13, the sealing ring having a production-related exterior diameter da; and
two machine elements to be sealed against one another, the first machine element comprising a housing, the second machine element comprising a rod substantially arranged concentrically inside the housing,
wherein the first machine element has an installation groove for the sealing ring that is open radially in a direction of the second machine element, with a groove base which has a diameter dN, and
wherein a ratio of da to dN is 1.01 to 1.05.

18. The sealing arrangement of claim 16, wherein the installation groove, when viewed in section, is substantially rectangular.

19. The sealing arrangement of claim 17, wherein the installation groove, when viewed in section, is substantially rectangular.
